(19) United States
(12) Patent Application Publication
(10) Pub. No.: US 2025/0021846 A1
(43) Pub. Date: Jan. 16, 2025

(54) METHODS FOR CONFIDENCE ASSESSMENT WITH FEATURE IMPORTANCE IN DATA DRIVEN ALGORITHMS

(71) Applicant: Schlumberger Technology Corporation, Sugar Land, TX (US)

(72) Inventors: Jeffrey Miles, Arlington, MA (US); Paul Ryan Craddock, Scituate, MA (US); Jinwoo Go, Atlanta, GA (US)

(21) Appl. No.: 18/352,873

(22) Filed: Jul. 14, 2023

(51) Int. Cl. G06N 7/01

(52) U.S. Cl. CPC G06N 7/01

(57) ABSTRACT

Embodiments presented provide for a method for establishing a confidence assessment for data. Data may be segregated by features importance during the confidence assessment, allowing evaluators the ability to determine the quality of data being processed by the method.

### CROSS-REFERENCE TO RELATED APPLICATIONS

None

### FIELD OF THE DISCLOSURE

Aspects of the disclosure relate to verifying data quality and artificial intelligence modeling. More specifically, aspects of the disclosure relate to methods for confidence assessment for data using feature importance in data driven algorithms.

### BACKGROUND

Many methods of machine learning (ML) have been developed and can be broadly grouped under the umbrella of data-driven algorithms or statistical learning. A non-exhaustive list of ML methods includes Decision Tree, Random Forest, Support Vector Machine, K-Means Clustering, Logit Regression, Artificial Neural Networks, Convolutional Neural Networks, and Naive Bayes. The method can be based on supervised, unsupervised, semi-supervised, and reinforcement learning. These methods have been applied to a large number of classification (e.g., categorical dependent variables) and/or regression (e.g., continuous dependent variables) problems.

However, many ML methods lack interpretability and can only make predictions without rigorous estimates of uncertainty and confidence in the predicted answers. Moreover, ML algorithms tend to perform poorly when extrapolating away from the domain or range of the data samples on which the algorithm was optimized (i.e., outside the range of the algorithm's training data).

Several methods exist to assess feature importance—i.e., the sensitivity of a model output value to various input values. Feature importance is useful for identifying which model inputs (features) provide predictive strength in the model and those which carry no such predictive information. Feature importance is; therefore, useful for model interpretability. Methods for quantifying feature importance include Shapley additive explanations (SHAP), local interpretable model-agnostic explanations (LIME), accumulated local effects (ALE), mean decrease in impurity (MDI or Gini Importance), and mean decrease in accuracy (MDA or Permutation Importance). Generally speaking, these methods calculate a perturbation of a model output value from a perturbation, permutation, or elimination of each model input, and then rank or score the relative importance of each model input. A common approach of these methods is that features are interrogated independently, such that interpretation of feature importance scores or rankings becomes challenging for highly correlated features.

There exist a variety of methods for outlier detection. Outlier detection is beneficial for estimating the confidence or reliability of a value output from a model prediction using feature data not included in the original model optimization. The standard score (also known as Z-score) and the box-and-whisker plot are two, widespread, statistics tools for outlier detection. The Z-score quantifies the number of standard deviations a sample datum is away from the mean of the dataset. Samples with Z-score values above a defined threshold (e.g., 2 standard deviations) are considered outliers. The score is calculated for univariate data (i.e., a single variable or feature) and works best when applied to data that is normally distributed (Gaussian) or nearly so. The box-and-whisker plot computes data percentiles from the dataset and determines outliers based on their individual percentile value compared to one or more thresholds, such as 25^{th} percentile (1^{st} quartile), 75^{th} percentile (3^{rd} quartile), inter-quartile range (IQR), and IQR×1.5. Percentile metrics are also calculated for single variables, but can be applied to non-Gaussian distributions. Approaches for computing outliers in univariate data can be extended to multivariate data, with each variable having their own distribution. For example, in the case of Z-score, standard deviations can be represented as ellipses contoured around (uncorrelated) bivariate data. Other disclosed methods directed toward multivariate data distribution analysis include Minimum Covariance Determinant (MCD).

There is a need to provide an apparatus and methods that are easier to operate than conventional apparatus and methods.

There is a further need to provide apparatus and methods that do not have the drawbacks discussed above.

There is a still further need to reduce economic costs associated with operations and apparatus described above with conventional tools.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are therefore not to be considered limiting of its scope, for the disclosure may admit to other equally effective embodiments without specific recitation. Accordingly, the following summary provides just a few aspects of the description and should not be used to limit the described embodiments to a single concept.

In one example embodiment, a method is disclosed. The method may comprise performing a principal component analysis on k model original features to obtain k principal components representing uncorrelated input data distributions, wherein k is an integer. The method may also comprise fitting a proxy model using k principal component inputs to an output property. The method may also comprise computing feature importance weights, for each of the k principal component inputs. The method may also comprise parameterizing k principal component input data distributions. The method may also comprise relaxing the input data distributions of each of the k principal component input data distributions according to a normalized feature importance weight. The method may also comprise identifying any new sample data in-distribution to weighted probabilities compared to assigned cut-offs. The method may also comprise identifying sample outliers using visual cues. The method may also comprise displaying the sample outliers.

In another example embodiment, a method is disclosed. The method may include steps of performing a principal component analysis on k model original features to obtain k principal components representing uncorrelated input data distributions. The method may also comprise fitting a proxy model using k principal component inputs to an output property. The method may also comprise computing feature importance weights for the each k principal component input. The method may also comprise parameterizing k principal component input data distributions as probability density functions. The method may also comprise relaxing the probability density functions of each k principal component input data distributions according to a normalized feature importance weight. The method may also comprise identifying any new sample data out-of-distribution according to weighted probabilities compared to assigned cut-offs. The method may also comprise identifying sample outliers using visual cues. The method may also comprise displaying the sample outliers.

In another example embodiment, a method is disclosed. The method may comprise performing a principal component analysis on k model original features to obtain k principal components representing uncorrelated input data distributions, wherein k is an integer greater than 1. The method may also comprise fitting a proxy model using the k principal component inputs to an output property representing a geological feature. The method may also comprise computing feature importance weights for each of the k principal component inputs. The method may also comprise parameterizing k principal component input data distributions. The method may also comprise relaxing the input data distributions of each of the k principal component input data distributions according to a normalized feature importance weight. The method may also comprise identifying any new sample data in distribution to weighted probabilities compared to assigned cut-offs. The method may also comprise identifying sample outliers using visual cues. The method may also comprise saving the sample outliers in a non-volatile memory.

In another example embodiment, an article of manufacture is disclosed, wherein the article of manufacture is configured to be performed on a computing device, wherein the performance is a method configured to include performing a principal component analysis on k model original features to obtain k principal components representing uncorrelated input data distributions, wherein k is a integer greater than 1. The method performed by the article of manufacture may include fitting a proxy model using the k principal component inputs to an output property representing a geological feature. The method performed by the article of manufacture may include computing feature importance weights for each of the k principal component inputs. The method performed by the article of manufacture may include parameterizing k principal component input data distributions. The method performed by the article of manufacture may include relaxing the input data distributions of each of the k principal component input data distributions according to a normalized feature importance weight. The method performed by the article of manufacture may include identifying any new sample data in-distribution to weighted probabilities compared to assigned cut-offs. The method performed by the article of manufacture may include identifying sample outliers using visual cues and saving the sample outliers in a non-volatile memory.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted; however, that the appended drawings illustrate only typical embodiments of this disclosure and are therefore not be considered limiting of its scope, for the disclosure may admit to other equally effective embodiments.

FIG. 1 is a curve based representation of a data driven model featuring inputs and outputs.

FIGS. 2A and 2B show an example dataset in which original data features are correlated and subsequently uncorrelated when rotated using principal components analysis onto their principal components.

FIG. 3 is an example of feature sensitivity.

FIG. 4 is an example of parameterizing a training data distribution with a Gaussian pdf to provide outlier detection that may be applied to new data samples.

FIG. 5 is a visual example of a novel confidence assessment method for a hypothetical model using two input features, where outlier detection is performed using a modified Gaussian parameterization that includes the sensitivity of the model to different input features.

FIG. 6 is an illustrative use of a weighted out-of-distribution indicator.

FIG. 7 is an example flow chart for one combination of outlier detection and feature importance for confidence assessment in a data-driven model prediction.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood; however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, components, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

The methods and systems described herein disclose a novel method of making a confidence estimate on the prediction from a data-driven model using inputs from any new sample data, based on the model's sensitivity to the different inputs (features) and the similarity in feature space between any new sample data and the original ensemble data used to train the model. Embodiments of the disclosure may be used in a variety of industries. One such non-limiting embodiment may be used in hydrocarbon recovery operations where data may be non-homogeneous but the need for accuracy of prediction is great. Other data intensive applications may use embodiments, such as computational fluid dynamics.

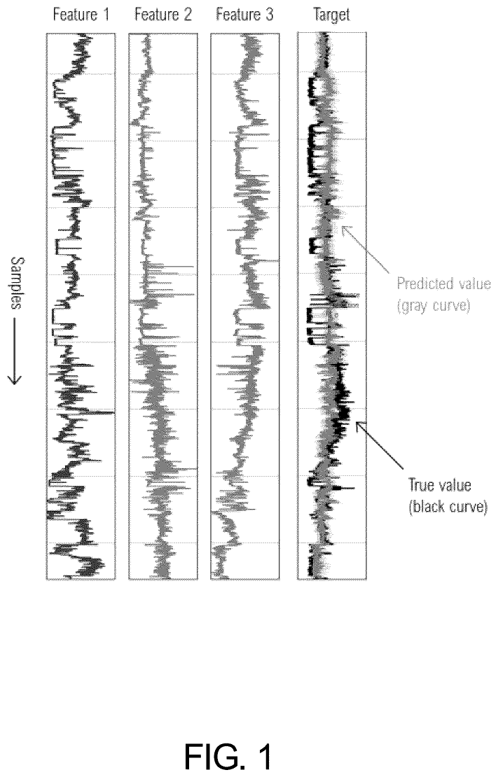

FIG. 1 shows for a set of earth formation samples, the predicted values for a property of interest (“Target”) obtained by fitting a set of measured input properties (“Features 1-3”) to a data-driven machine learning model. The ground-truth values for the same property of interest are also shown. The model inputs, true target value, and predicted target value are represented as continuous curves, such as is commonly shown for wellbore logging plots. It is apparent that this model can make an accurate prediction of the true target value only for a subset of the samples. An investigation of the samples for which the model prediction is erroneous would reveal that those samples contain a set of input features whose distribution is different to that of the same features in the original ensemble of samples used to train the model. In other words, predictions have been made on outlier samples, and the predictions may fail for those samples. It is desired to make predictions of accuracy based upon any set of data given and to allow researchers the ability to easily determine if the data provided will be accurate.

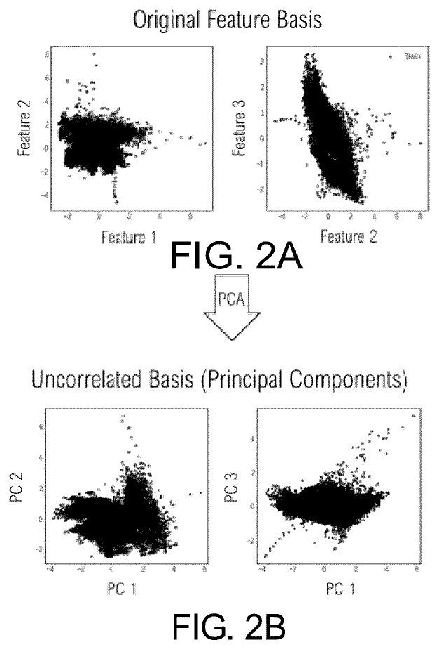

Several techniques of outlier detection are possible, such as by calculating data ranges as percentiles and standard deviations. In one embodiment, outliers are identified using a multi-variative Gaussian parameterization. In one example embodiment, this parameterization is done assuming uncorrelated model features (i.e., zero covariance between the model inputs). It is known; however, that many properties of earth formations are correlated to a greater or lesser extent and are not truly independent. This is illustrated in FIG. 2, where the same set of three features shown in FIG. 1 are now cross plotted on cartesian axes. The full covariance could be included in a more complicated Gaussian parameterization, but this is not preferred because of complexity, and it would not easily enable the use of feature sensitivities, described below. Alternatively, the original model features can be rotated onto uncorrelated bases using principal components analysis (PCA). As defined herein, PCA projects the original feature basis (which are correlated in the training data) onto the basis of principal components in which the data are statistically uncorrelated. Therefore, one embodiment of an outlier detection algorithm is the parameterization of a dataset using a multi-variate Gaussian distribution, where the component features of the data samples have been transformed by PCA such that they are statistically uncorrelated. Note that PCA is performed on the original ensemble of training samples (i.e., training dataset) and the extracted PCA parameters are then applied to any new samples in a testing dataset. FIG. 2 illustrates an example of PCA. The number of principal components may be the same as the number of original features, such that there is no dimensionality reduction.

The probability of any new sample falling within the distribution space of the original ensemble data can then be represented by the joint probability density of the normal distribution in the space of k principal components:

$$P = {\prod }_{i = 1}^{k} \frac{1}{{σ}_{i} \sqrt{2 π}} {e}^{- \frac{1}{2} {( \frac{{x}_{i} - {μ}_{i}}{{σ}_{i}} )}^{2}}$$

This probability density function (PDF) can be useful as an outlier indicator (e.g., standard score or Z-score), but the function does not fully capture the relative importance of the input features in the model. Depending on the relative sensitivity of the model to different features, the distance between the training data and a new test sample along one component may be much more important than the same distance along another component.

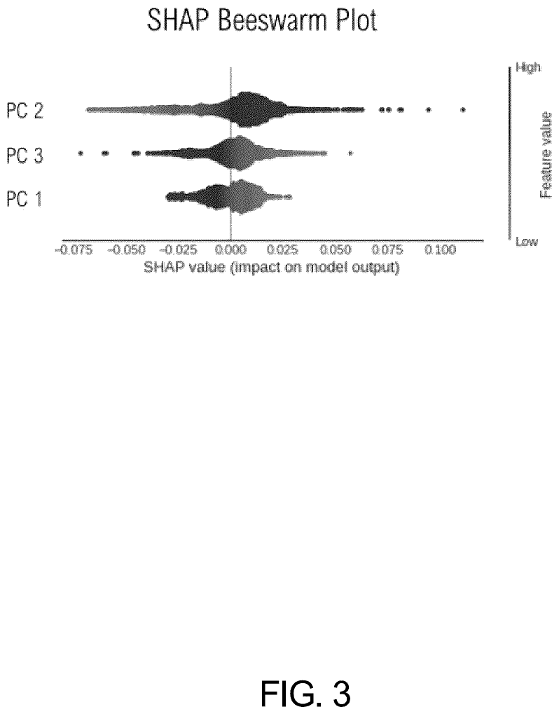

In one embodiment, an appropriate vector of weights w can be used to modify the above outlier detection scheme. Conceptually, the weights describe how much the confidence in model predictions should be affected by deviations from the mean of the training data along each axis. The axes in this embodiment may represent principal component axes or the basis of the original input features. Several methods of sensitivity analysis are available. As an example, FIG. 3 shows relative feature sensitivities derived from a SHAP (Shapley additive explanations) analysis. The theory underlying SHAP is described elsewhere. Some comments regarding the example plot are worth noting. The model sensitivity is computed for each input feature separately, which are labeled “PC 1-3” in this example. Model sensitivity may be computed for any inputs to the model, including (as in this example) inputs that represent principal-component combinations of data attributes.

Each data point on the plot represents a sample from an ensemble of data, in this case the same original ensemble of training samples (i.e., the training dataset). The impact on the model output is indicated by the position (i.e. the SHAP value) of the samples on the horizontal coordinate. The SHAP value for each sample represents the difference in the model output induced by substituting the true value for a model input in place of the mean value for that input feature, where the mean is computed from the full ensemble. The further the deviation from zero, the greater the model sensitivity to the feature. Thus, in one or more embodiments, a feature importance can be derived from the spread of the SHAP values for each feature as calculated from the range, interquartile range, standard deviation, or any other appropriate metric or statistic. In one embodiment, the feature importance weights w are calculated as the standard deviation of the SHAP value distributions for each feature and then normalized with respect to the most important feature with unit weight (wᵢ=1).

In one embodiment, the joint PDF above may then be modified for each model input (e.g., k principal component features from the training dataset) according to the relative feature importance weights w for that set of inputs. The modification may be justified by the fact that a certain amount of deviation along one axis of input features can be much more or less important for model confidence than the same deviation along another axis. Therefore, the feature importance weights w can be applied to the standard score of any data point, i.e.:

$$\frac{( {z}_{i} - {μ}_{i} )}{{σ}_{i}} ,$$

being its number of standard deviations from the mean along each principal component. In practice, this only requires a reweighting of the standard deviations that we fitted to the ensemble training data along each PC, e.g.: σᵢ→σᵢ/wᵢ.

The weighted PDF in this case becomes:

$$P = {\prod }_{i = 1}^{k} \frac{{w}_{i}}{{σ}_{i} \sqrt{2 π}} {e}^{- \frac{{w}_{i}^{2}}{2} {( \frac{{x}_{i} - {μ}_{i}}{{σ}_{i}} )}^{2}}$$

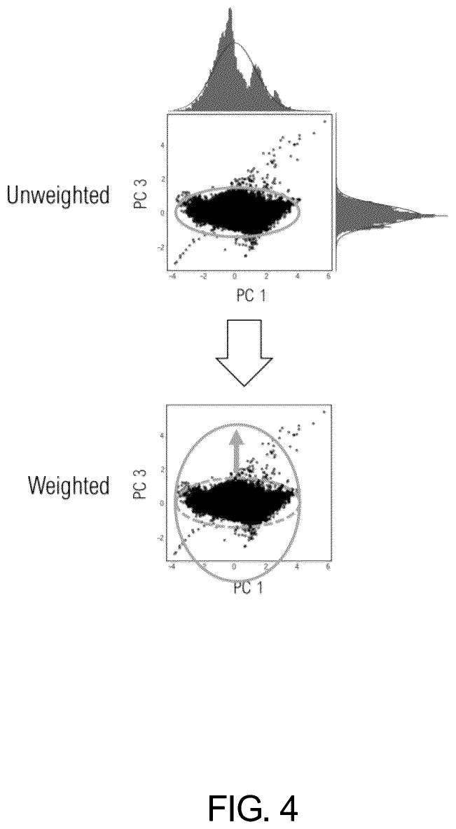

This is the coherent way of inserting the weights to penalize deviations along high-weight axes and to reduce the impact of deviations along less-important axes. The weights serve to modify the effective distance in standard score space of a new sample with respect to the training dataset mean. FIG. 4 provides a conceptual illustration for a model using principal component features as inputs and for which weighting is applied to principal components 1 and 3, where principal component 1 has the most importance (w1=1) and principal component 3 has lower importance (w3<<1). In the upper plot, the standard deviations of the sample distributions along each principal component are unweighted. In the lower plot, those standard deviations are relaxed for the principal component that has lower importance. In effect, some samples that would be classified as outliers (outside bounds of the ellipse) using unweighted criteria are now classified as in-distribution (inside bounds of the ellipse) because the distance metric is relaxed along the axis with low feature importance.

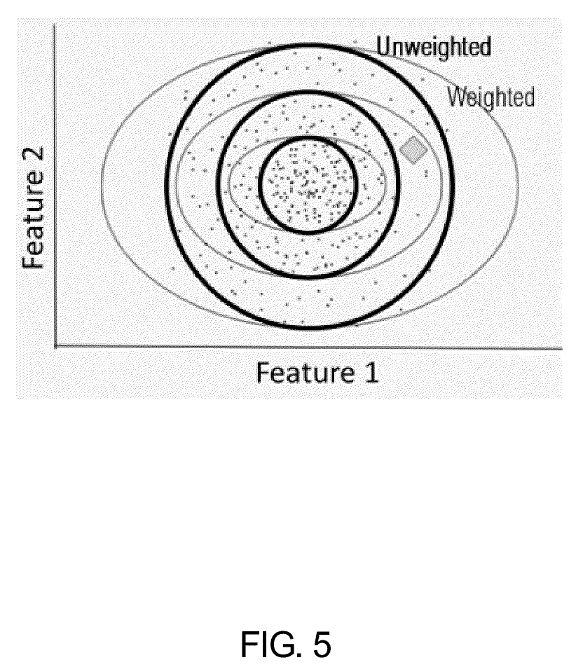

FIG. 5 shows an analogous visual example of the novel confidence assessment method for a hypothetical model using two input features. The PDF of these hypothetical training data (circular points) are parameterized as Gaussian distributions (black contours, representing integer standard deviations of the distribution along each axis), the widths (i.e., standard deviations) of which are equal along the two feature dimensions. The Gaussian parameterization for outlier detection is modified (gray contours) using the above equation to account for the relative importance of the two input features for the algorithm predictions. This example illustrates a case where Feature 1 is less important than Feature 2 (i.e., Feature 1 has less impact on the model predictions), and so the confidence metric is penalized less (or “relaxed”) for distance along Feature 1 axis than Feature 2 axis. For the purposes of exemplifying unweighted and weighted outlier detection, a two-standard deviation (2σ) is used here as the cut-off between in-distribution and out-of-distribution. A new sample (diamond) would be classified as an outlier for an unweighted Gaussian distribution, because it falls outside of the 2σ value for Feature 1. However, noting here that Feature 1 has less importance in the model prediction, the weighted Gaussian distribution is relaxed along Feature 1 axis, and the new sample (diamond) is classified as in-distribution. This novel weighting results in a more meaningful assessment of confidence in predictions for the new sample with respect to the training dataset.

In defining cut-offs for whether any new sample is in-distribution or out-of-distribution, it is convenient to use the log-probability, taking the natural logarithm of the weighted PDF:

$$log {P}_{w} = - \frac{k}{2} log 2 π + {\sum }_{i = 1}^{k} [ log ( \frac{{w}_{i}}{{σ}_{i}} ) - \frac{{{w}_{i}^{2} ( {z}_{i} - {μ}_{i} )}^{2}}{2 {σ}_{i}^{2}} ]$$

If we define the cut-off (boundary) using a threshold of t weighted-standard deviations along each principal component axis, then the threshold on log P_{w} will be:

$${log {P}_{w} \vert}_{cutoff} = - \frac{k}{2} ( {t}^{2} + log 2 π ) + {\sum }_{i = 1}^{k} log ( \frac{{w}_{i}}{{σ}_{i}} )$$

Those samples that are outliers have log P_{w} values less than the cutoff value.

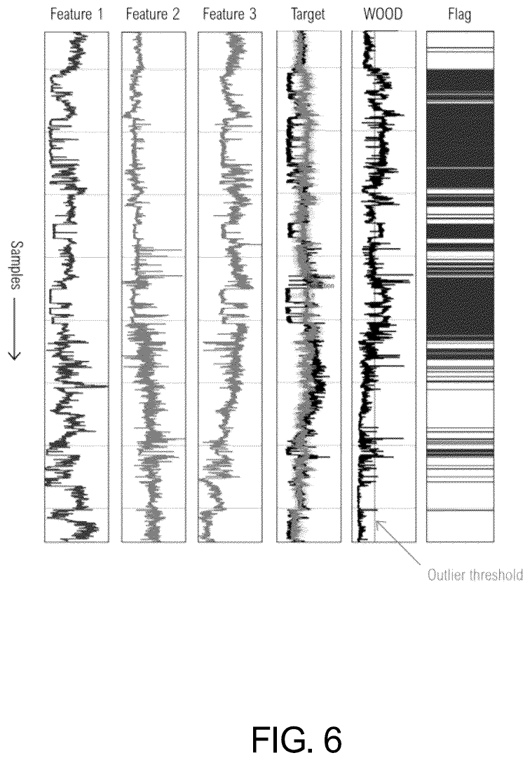

FIG. 6 illustrates the usefulness of the novel confidence indicator, here termed the weighted-out-of-distribution indicator (WOOD). FIG. 6 shows the same model prediction as in FIG. 1. To this prediction is now added a WOOD indicator, shown as a continuous, black curve for all samples. Overlaying the WOOD is a threshold or cut-off for discriminating in-distribution versus out-of-distribution samples. In this example, samples with WOOD values that fall to the right of the threshold are deemed to be outliers. An optional flag is shown in the right-most track which indicates whether confidence can be placed on the model prediction. The flag is colored for samples for which the prediction is not confident because those samples are identified as outliers. The flag for lacking confidence in the model prediction corresponds satisfactorily to those samples for which the model prediction is shown to be in error. In the illustrated example, the flag is activated using only outlier detection as a criterion. However, extensions to this flag can be incorporated—for example, a flag that considers whether the estimated uncertainty about a point-estimate prediction exceeds a defined threshold.

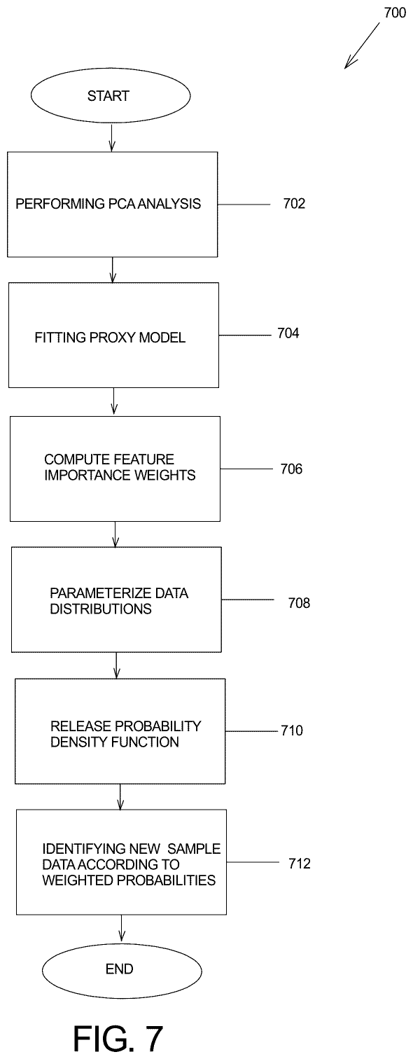

FIG. 7 discloses a visual workflow (flow chart) for one combination of outlier detection and feature importance for confidence assessment in a data-driven model. The method 700 provides several steps for completion. The method 700 illustrated provides only one example embodiment and should not be considered limiting. The method 700 starts at 702 with performing a principal component analysis (PCA) on k model original features (inputs) to obtain k principal components representing uncorrelated input data distributions. At 704, the method continues fitting a proxy model using k principal component inputs to an output property (target) using linear regression. At 706, the method continues at computing feature importance weights, w, for each k principal component inputs in the proxy linear regression model. At 708, the method continues with parameterizing the k principal component input data distributions as Gaussian probability density functions (PDF). At 710 the method continues with relaxing the PDF of each k principal component input data distributions according to their normalized feature importance weight, w. At 712, the method continues with identifying any new sample data in-distribution or out-of-distribution according to their weighted probabilities compared to assigned cut-offs. Sample outliers are identified using visual cues like a confidence red flag.

In one example embodiment, a method is disclosed. The method may comprise performing a principal component analysis on k model original features to obtain k principal components representing uncorrelated input data distributions, wherein k is an integer. The method may also comprise fitting a proxy model using k principal component inputs to an output property. The method may also comprise computing feature importance weights, for each of the k principal component inputs. The method may also comprise parameterizing k principal component input data distributions. The method may also comprise relaxing the input data distributions of each of the k principal component input data distributions according to a normalized feature importance weight. The method may also comprise identifying any new sample data in-distribution to weighted probabilities compared to assigned cut-offs. The method may also comprise identifying sample outliers using visual cues. The method may also comprise displaying the sample outliers.

In another example embodiment, the method may be performed wherein the displaying the sample outliers includes visually representing the sample outliers.

In another example embodiment, the method may be performed wherein the displaying the sample outliers includes printing the sample outliers.

In another example embodiment, the method may be performed wherein the fitting a proxy model using k principal component inputs to an output property is using linear regression.

In another example embodiment, the method may be performed wherein the parameterized k principal component input data distributions is performed as Gaussian probability density functions.

In another example embodiment, the method may be performed wherein the identifying sample outliers using visual cues includes a confidence red flag.

In another example embodiment, a method is disclosed. The method may include steps of performing a principal component analysis on k model original features to obtain k principal components representing uncorrelated input data distributions. The method may also comprise fitting a proxy model using k principal component inputs to an output property. The method may also comprise computing feature importance weights for the each k principal component input. The method may also comprise parameterizing k principal component input data distributions as probability density functions. The method may also comprise relaxing the probability density functions of each k principal component input data distributions according to a normalized feature importance weight. The method may also comprise identifying any new sample data out-of-distribution according to weighted probabilities compared to assigned cut-offs. The method may also comprise identifying sample outliers using visual cues. The method may also comprise displaying the sample outliers.

In another example embodiment, the method may be performed wherein the displaying the sample outliers includes visually representing the sample outliers.

In another example embodiment, the method may be performed wherein the displaying the sample outliers includes printing the sample outliers.

In another example embodiment, the method may be performed wherein the fitting a proxy model using k principal component inputs to an output property is using linear regression.

In another example embodiment, the method may be performed wherein the parameterized k principal component input data distributions is performed as Gaussian probability density functions.

In another example embodiment, the method may be performed wherein the identifying sample outliers using visual cues includes a confidence red flag.

In another example, a method is disclosed. The method may comprise performing a principal component analysis on k model original features to obtain k principal components representing uncorrelated input data distributions, wherein k is an integer greater than 1. The method may also comprise fitting a proxy model using the k principal component inputs to an output property representing a geological feature. The method may also comprise computing feature importance weights, for each of the k principal component inputs. The method may also comprise parameterizing k principal component input data distributions. The method may also comprise relaxing the input data distributions of each of the k principal component input data distributions according to a normalized feature importance weight. The method may also comprise identifying any new sample data in-distribution to weighted probabilities compared to assigned cut-offs. The method may also comprise identifying sample outliers using visual cues. The method may also comprise saving the sample outliers in a non-volatile memory.

In another example embodiment, the method may be performed wherein the parameterized k principal component input data distributions is performed as Gaussian probability density functions.

In another example embodiment, the method may be performed wherein the fitting the proxy model using k principal component inputs to an output property uses linear regression.

In another example embodiment, the method may be performed wherein the method is configured to be performed on one a computer, a laptop and a server.

In another example embodiment, an article of manufacture is disclosed, wherein the article of manufacture is configured to be performed on a computing device, wherein the performance is a method configured to include performing a principal component analysis on k model original features to obtain k principal components representing uncorrelated input data distributions, wherein k is a integer greater than 1. The method performed by the article of manufacture may include fitting a proxy model using the k principal component inputs to an output property representing a geological feature. The method performed by the article of manufacture may include computing feature importance weights, for each of the k principal component inputs. The method performed by the article of manufacture may include parameterizing k principal component input data distributions. The method performed by the article of manufacture may include relaxing the input data distributions of each of the k principal component input data distributions according to a normalized feature importance weight. The method performed by the article of manufacture may include identifying any new sample data in-distribution to weighted probabilities compared to assigned cut-offs. The method performed by the article of manufacture may include identifying sample outliers using visual cues and saving the sample outliers in a non-volatile memory.

In the following description, description is provided related to measurements obtained during wireline operations generally performed, as described above. As will be understood, various changes and alterations may be accomplished during the attainment of the desired measurements and as such, methods described should not be considered limiting.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method, comprising:
performing a principal component analysis on k model original features to obtain k principal components representing uncorrelated input data distributions, wherein k is an integer;
fitting a proxy model using k principal component inputs to an output property;
computing feature importance weights, for each of the k principal component inputs;
parameterize k principal component input data distributions;
relaxing the input data distributions of each of the k principal component input data distributions according to a normalized feature importance weight;
identifying any new sample data in-distribution to weighted probabilities compared to assigned cut-offs;
identifying sample outliers using visual cues; and
displaying the sample outliers.

2. The method according to claim 1, wherein the displaying the sample outliers includes visually representing the sample outliers.

3. The method according to claim 1, wherein the displaying the sample outliers includes printing the sample outliers.

4. The method according to claim 1, wherein the fitting a proxy model using k principal component inputs to an output property is using linear regression.

5. The method according to claim 1, wherein the parameterized k principal component input data distributions is performed as Gaussian probability density functions.

6. The method according to claim 1, wherein the identifying sample outliers using visual cues includes a confidence red flag.

7. A method, comprising:
performing a principal component analysis on k model original features to obtain k principal components representing uncorrelated input data distributions;
fitting a proxy model using k principal component inputs to an output property;
computing feature importance weights for the each k principal component input;
parameterize k principal component input data distributions as probability density functions;
relaxing the probability density functions of each k principal component input data distributions according to a normalized feature importance weight;
identifying any new sample data out-of-distribution according to weighted probabilities compared to assigned cut-offs;
identifying sample outliers using visual cues; and
displaying the sample outliers.

8. The method according to claim 7, wherein the displaying the sample outliers includes visually representing the sample outliers.

9. The method according to claim 7, wherein the displaying the sample outliers includes printing the sample outliers.

10. The method according to claim 7, wherein the fitting a proxy model using k principal component inputs to an output property is using linear regression.

11. The method according to claim 7, wherein the parameterized k principal component input data distributions is performed as Gaussian probability density functions.

12. The method according to claim 7, wherein the identifying sample outliers using visual cues includes a confidence red flag.

13. A method, comprising:
performing a principal component analysis on k model original features to obtain k principal components representing uncorrelated input data distributions, wherein k is an integer greater than 1;
fitting a proxy model using the k principal component inputs to an output property representing a geological feature;
computing feature importance weights, for each of the k principal component inputs;
parameterizing k principal component input data distributions;
relaxing the input data distributions of each of the k principal component input data distributions according to a normalized feature importance weight;
identifying any new sample data in-distribution to weighted probabilities compared to assigned cut-offs;
identifying sample outliers using visual cues; and
saving the sample outliers in a non-volatile memory.

14. The method according to claim 13, wherein the parameterized k principal component input data distributions is performed as Gaussian probability density functions.

15. The method according to claim 13, wherein the fitting the proxy model using k principal component inputs to an output property uses linear regression.

16. The method according to claim 13, wherein the method is configured to be performed on one of a computer, a laptop and a server.

17. An article of manufacture configured to be performed on a computing device, wherein the performance is a method configured to include:
performing a principal component analysis on k model original features to obtain k principal components representing uncorrelated input data distributions, wherein k is an integer greater than 1;
fitting a proxy model using the k principal component inputs to an output property representing a geological feature;
computing feature importance weights, for each of the k principal component inputs;
parameterizing k principal component input data distributions;
relaxing the input data distributions of each of the k principal component input data distributions according to a normalized feature importance weight;
identifying any new sample data in-distribution to weighted probabilities compared to assigned cut-offs;
identifying sample outliers using visual cues; and
saving the sample outliers in a non-volatile memory.
